(19) United States
(12) Patent Application Publication
(10) Pub. No.: US 2018/0129377 A1
(43) Pub. Date: May 10, 2018

(54) Cause Tracking

(71) Applicant: Terrence Nevins, Lynnwood, WA (US)

(72) Inventor: Terrence Nevins, Lynnwood, WA (US)

(21) Appl. No.: 15/804,950

(22) Filed: Nov. 6, 2017

Related U.S. Application Data
(60) Provisional application No. 62/417,326, filed on Nov. 4, 2016.

(51) Int. Cl. G06F 3/0482; G06Q 10/06; G06F 17/30

(52) U.S. Cl. CPC G06F 3/0482; G06F 17/30864; G06Q 10/063

(57) ABSTRACT

A cause-tracking service, which may provide classifications for relationships between entities and individual users in response to a user's description and selection of a plurality of causes and entities. A user may be enabled to select a business or entity which maps to one or more causes that match with at least one cause the individual user wishes to support. Accessing the matching instances may be enabled by a display on a website, application, or mobile application. Causes and entities associated with causes may be displayed, which may allow a user to have tools to personalize their experience with entities.

### FIELD

This disclosure relates generally to cause tracking.

### BACKGROUND

People who are cause-focused must rely on their own research to determine the impact of their choice to engage with certain businesses or organizations. A person may wish to support a cause they believe in by spending money at businesses that support that particular aim, conviction, community commitment, or movement. Before determining what a business relationship is to a cause, research is required to determine the relationship between the business and causes. In researching, a person generally relies on minimal information available to the public, which makes it complicated for people to determine which business entities align with which particular causes.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a cause tracking service, which may be a tool that is responsive to user selections and inquiries. It may collect and display information about mappings between entities and causes, such as charitable causes. An entity may be a person interested in supporting a cause or be a business that supports a cause. A cause tracking service may classify relationships between entities. For example, a person may want to know of a relationship between various businesses and causes to determine if purchasing from a business will support a cause the person wishes to support. A person may be in search of a certain type of business and select among those businesses according to the causes they align with.

Each cause may be supported by one or more businesses. For example, many businesses may support a local environmental cause or a local theater arts development cause. A cause may have a subset of causes that are bound by the overarching cause. For example, a local environmental cause may have a branch of its organization dedicated to preserving natural water sources, natural woodland areas, or supporting lobbying efforts. A user may wish to influence the success of a particular community cause by spending money or volunteering time at particular business or other entity having causes that match up with those of the person.

Multiple causes may be of interest to a person, so a person may be mapped to a set of different causes. A person who is interested in preserving earth's natural environment may be enabled to support a cause, for example, that protects the water sources in the environment, and another that protects habitat for wild animals.

A business or other entity may associate itself with a cause or set of causes by contributing to or having a working relationship with certain entities that may be aligned with those causes. For example, a banking business may associate itself with both a non-profit organization that provides free spay/neuter clinics, and an organization that provides free veterinary care for stray animals, or associate itself with another unrelated charitable organization.

A person may select a business based on the causes the business supports. Aside from shopping for goods, a person or entity may be in the market for educational activities, volunteer activities, virtual activities, fundraising events, or other forms of engagement.

A cause tracking service may be used as a tool to capture, catalog, store, retrieve, modify and update data used for classification of relationships between entities and individual and business users. A cause tracking service may enable a user to search for entities based on the causes those entities are associated with. A user may be able to search for a business that maps to causes that match at least one of the causes the individual user aligns with. A display of matching instances may be displayed on a website, application, or mobile application.

### BRIEF DESCRIPTION OF THE DRAWINGS

FIG. 1 is a flow diagram for a cause tracking process according to one embodiment.

FIG. 2 illustrates a user interface layout for a device application, or website, using a cause tracking service, according to one embodiment.

FIG. 3 illustrates a user interface layout for a device application, or website, using a cause tracking service, according to one embodiment.

FIG. 4 is a block diagram illustrating a representative mapping configuration of entities and charitable causes, according to one embodiment.

FIG. 5 illustrates a system capable of supporting a cause tracking service, according to one embodiment.

FIG. 6 is a component diagram of a computing device which may support a cause tracking service process according to one embodiment.

### DETAILED DESCRIPTION

Many of the attendant features may be more readily appreciated as they become better understood by reference to the following detailed description considered in connection with the attached drawings, in which like parts are assigned like numerals.

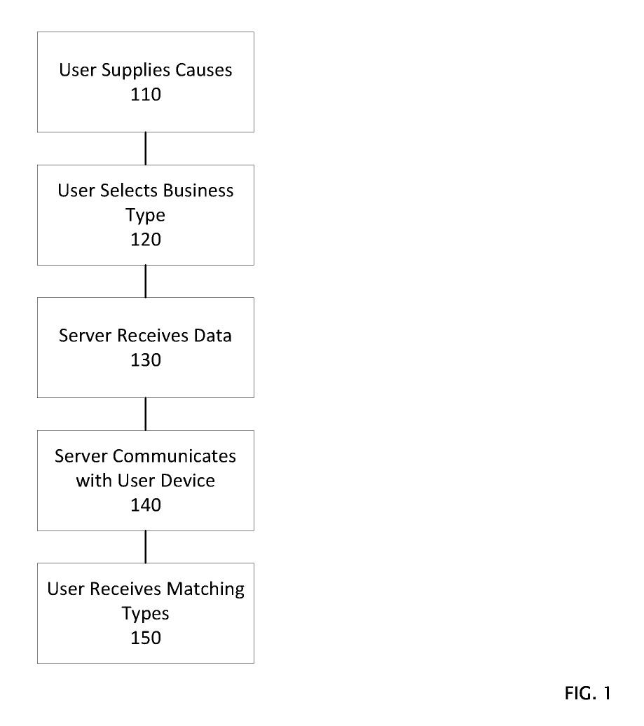

FIG. 1 is a flow diagram for a cause tracking process according to one embodiment. At User Supplies Causes 110, a user such as a person, for example, may be enabled to supply the description, priority weight, ranking and relevance of causes that align with their individual interest, or interest of another individual whose interest person user wishes to replicate. For example, a user may wish to commit to causes that their favorite movie star aligns with. An individual's interest may be determined by various factors and priority values that may enable categorization of causes.

A priority value may depend on the level of commitment an individual attaches to a cause, for example. A user may be enabled to define other factors to be considered when assessing the worthiness of a business or other type of entity. Such factors may include how a business or other entity carry out their activities with respect to a cause, which may count towards the values considered by an individual. For example, where a user tracks a business's activities with respect to a cause, then those activities may be categorized as “good” activities or “bad” activities for that user. An example of a “good” activity may be a company receiving a national award for civic services. Some activities, such as political or religious activities, may be considered good by some users and bad by other users.

In addition to assigning priority values, a user may also be enabled to sort their causes by assigning ranking or relevance weights to causes, using a self-evaluating means of interacting with a computer system to target desired personal interests, aims, or commitments, for instance. Some examples of a self-evaluating means of interacting with a computer system are a scoring system, a color scheme, or an emotional reaction scheme computer operation feature which may enable a user to indicate a cause's ranking or relevance degree as related to user's primary interests, commitments, aims, or associations, for example. To illustrate, if a user supports both solutions for homelessness and pet shelters, the user may assign a higher ranking or relevance score to actions supporting one or the other of those causes, even though both may be positive.

From another cause tracking perspective, a user's interest or aim may be to commit to a stand against a cause, such as another political party. Here a user being against a cause may be defined as a cause itself because it is a commitment a user has to avoid supporting some cause. Consequently, a user may have access to the ranking and relevance sorting system to avoid supporting causes. It would be apparent to someone with ordinary skill in the art that various algorithms and functions may enable a user to categorize their preferences for causes.

In another embodiment, an entity, business or other establishment, such as a non-profit organization, a club, or a school, may supply a description for the causes they wish to support or avoid or may select causes they wish to commit to from a retrieved list of causes. The business or other establishment may define a cause's priority value or accept a default value for each cause. An entity, like a business, may support more than one cause or a hierarchy of causes, because a cause may be selected by multiple entities. An entity's preferences may be organized similarly to individual user's cause preferences organization scheme described above.

At User Selects Business Type 120, a user may be enabled to select a business based on a display of search results. Where search results supply multiple businesses or entities, a user may narrow the search by filtering priority, ranking or relevance values, for example, since the user may be enabled to track an entity according to priority values along with other various factors. A person user may also be enabled to declare and modify a status or level of commitment toward a cause, as a way to distinguish themselves and their commitment to a cause or set of causes. It would be apparent to someone with ordinary skill in the art that various algorithms and functions may enable a user to filter their causes search results.

A cause tracking service may perform a search using a specified geographic area, another geographic area identifier, or other criteria, such as priority values, and may use strings naming causes that match the causes the person user selected. A user may be enabled to capture a business's or entity's information using any device such as a smartphone, a smartwatch or intelligent eyewear, for instance. Based on the input captured, cause tracking service may search and display causes that match the person user's profile. For instance, a person user may walk into a supermarket and point their image capturing device at a can of beans on a shelf. Here, cause tracking captures this data and associates the can of beans into a brand associated with a business entity. A display of causes the brand supports that match the person user's profile may be displayed on user's device.

Once a person has entered their cause data or set-up a profile on their cause tracking service account, they may be enabled to select a business type by using any device such as a smartphone, a smartwatch or intelligent eyewear, for instance, to search for businesses or other entities.

At Server Receives Data 130, a device may store, catalog, sort, or modify data for the purpose of determining a classification of a relationship between charitable entities that receive support, entities providing support, and individual users. In one embodiment, Server Receives Data 130 may store data used to determine a match for a user's affinity or interest to a cause or hierarchy of causes pertaining to that interest, and then a match of a user with an organization or entity that provides support to another organization.

At Server Communicates with User Device 140, a user may be presented with a display representing the classifications of entities that may provide the user with information for her to make a choice about which action to select. For example, the user may find a business that aligns with their causes and select an action to purchase a good or service from that particular business.

In other embodiment, a user may enter a URL to access a cause tracking service. At Server Receives Data 130, Server Receives Data 130 may receive a message indicating the user's location. At Server Communicates with User Device 140, in response to the location or other criteria captured, Server Communicates with User Device 140 may provide a website or communicate with an app on the user's device, enabling a user to perform an action, such as selecting, searching, or entering other businesses. At User Receives Matching Business Types 150, the businesses that support causes that match up with the causes the user selected may be represented in a display to the user.

A cause tracking service may apply in a commercial or non-commercial context. For example, at User Supplies Causes 110, users who volunteer their time to community causes may enter the number of hours they spent volunteering for a particular cause. As with any data entered by the user, a user's volunteer time may be visible to others. In one embodiment, a user may be able to take a picture during check-in when volunteering. A cause tracking service may be used by any entity, such as for the purpose of attracting interactions with other entities or individual users. For example, at User Supplies Causes 110, a business entity may create a profile by entering data regarding causes it supports, and selecting from a list of causes retrieved from causes previously stored in cause tracking service.

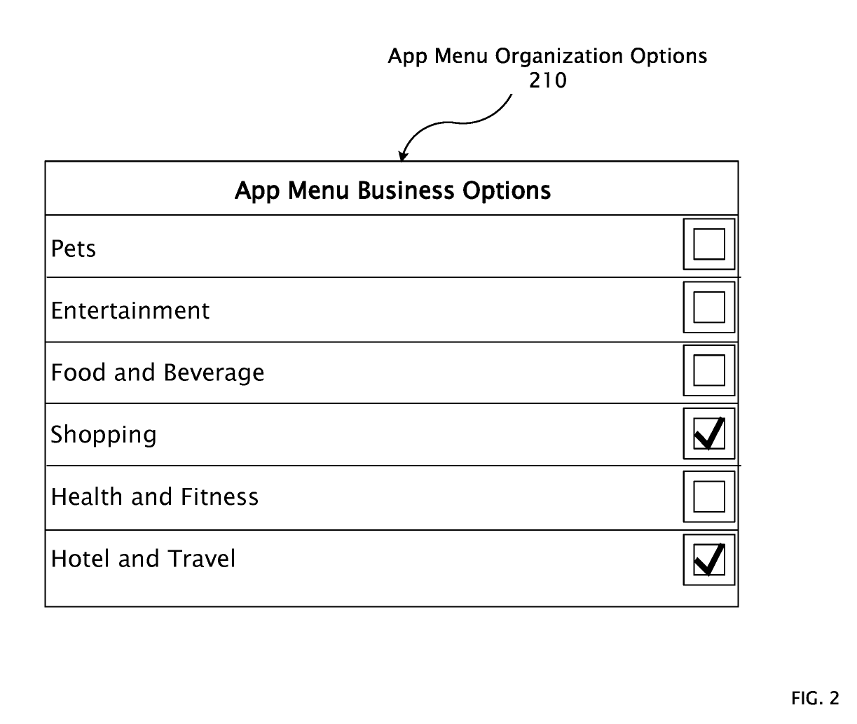

FIG. 2 illustrates a user interface layout for a device application, or website, using a cause tracking service according to one embodiment. In one embodiment, App Menu Organization Options 210 may display a drop-down menu of business type categories which a user may select from on her device or from a website, for example. A list of categories of business types may display a list of types of local business establishments. For example, a user in search of a shopping place to patronize that supports a cause may select Shopping to request a list of nearby places to shop. The user may also select Hotel and Travel option to get information about particular hotels and travel options that support the causes that match the user's individual causes. App Menu Organization Options 210 may have various components and configurations. For example, it may recognize voice data entries, be available in any language and in any commercial or non-commercial context. Cause Tracking Service may have commands which allow a user to submit a new cause or modify their list of causes.

In another embodiment, Cause Tracking Service may display a local map, which may allow a user to see causes supported by various local businesses or non-profits.

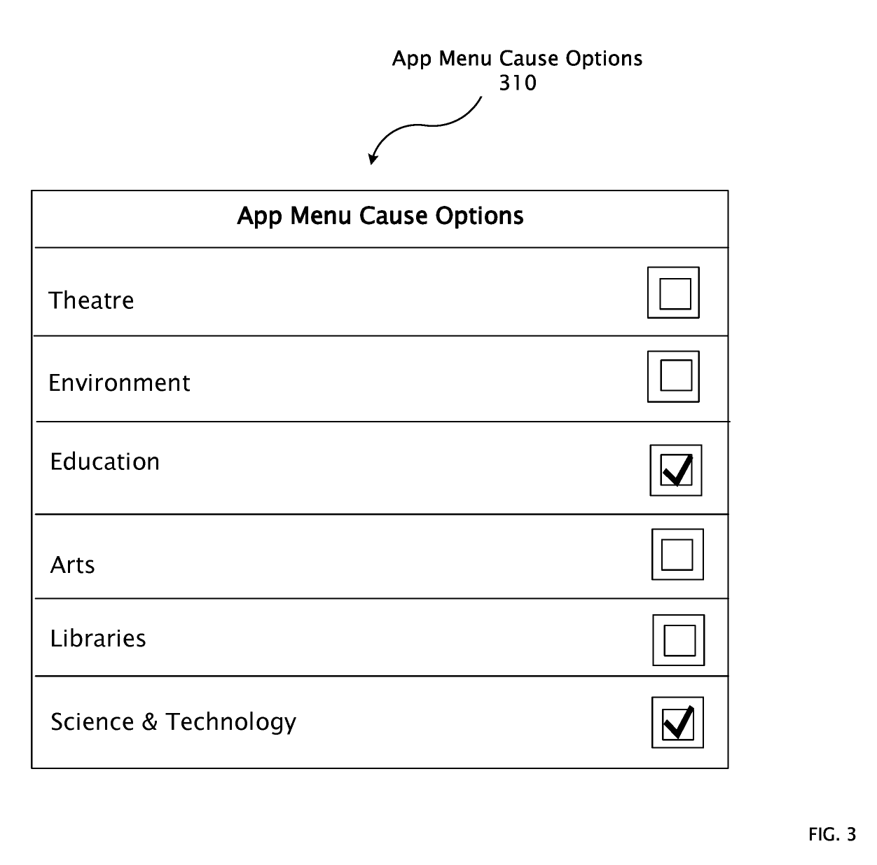

FIG. 3 illustrates a user interface layout for a device application, or website, using a cause tracking service, according to one embodiment. App Menu Cause Options 310 may display a drop-down menu of existing causes which a user may select from on her device or website. For example, a user seeking to support a cause may select Education as a category to find a list of local or national education-related causes. Or, the user may select Science & Technology instead or in addition to Education to find and select particular causes related to science and technology that the user cares about. App Menu Cause Options 310 may have various components and configurations, and it may be available in any language and any commercial or non-commercial context. Cause Tracking Service commands may allow a person to submit a new description of a cause or cause category and modify their list of options.

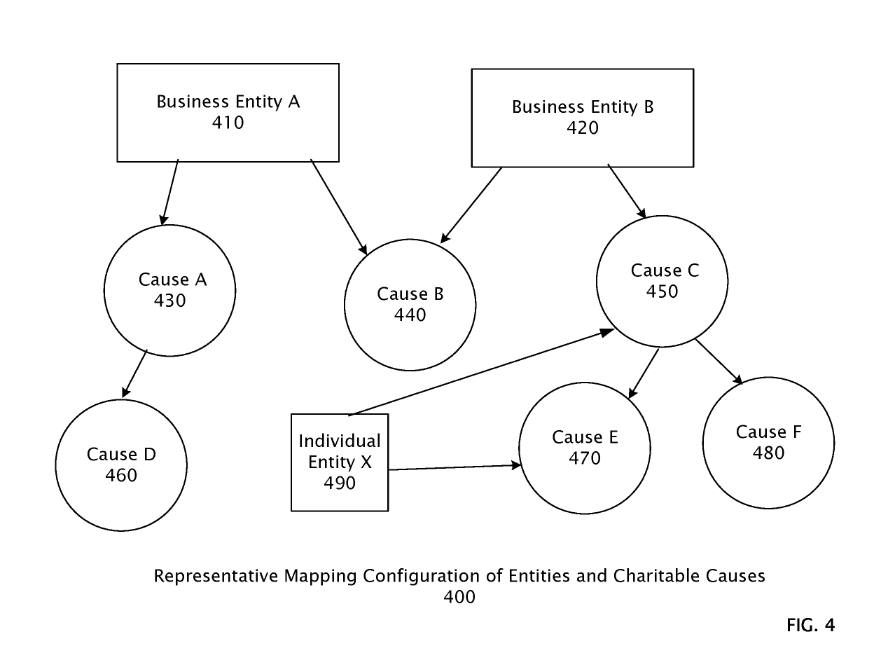

FIG. 4 is a block diagram illustrating a Representative Mapping Configuration of Entities and Charitable Causes 400, according to one embodiment. In classifying relationships between entities and users, Cause Tracking Service may be configured to capture, catalog, store, retrieve, modify and update data used for determining the relationships between entities, causes, and users. An entity may associate itself with related causes or sets of unrelated causes. An entity may, for instance, be a person or business interested in supporting a particular cause or set of causes. For example, here, Individual Entity X 490 may be a person who supports Cause C 450 and Cause E 470, while Business Entity A 410 supports Cause A 430 (which supports Cause D 460) and Cause B 440. Here, Cause Tracking Service may enable Individual Entity X 490 to determine the classification of the relationship between the causes she supports and Business Entity B 420 and Business Entity A 410. In this embodiment, Cause Tracking Service may enable Individual Entity X 490 to reveal that Business Entity B 420 aligns itself with causes that she cares about.

Cause Tracking Service may enable a cause, such as Cause B 440, to be supported by one or more entities. One or more causes in Cause Tracking Service may represent efforts that are bound by an overarching cause. This is illustrated with Cause E 470 and Cause F 480 as they relate to Cause C 450. As an example, Cause C 450's aim may be to introduce more art studies into higher education and a branch Cause E 470 of its organization may be dedicated to fundraising for student scholarships while another branch Cause F 480 may be dedicated to supporting curriculum design at participating universities.

In another embodiment, Cause Tracking Service may enable a user to select a product, for example, while walking in a store. The user may scan a code on the product or packaging, which may allow Cause Tracking Service to determine what causes a manufacturer or supplier of that product supports.

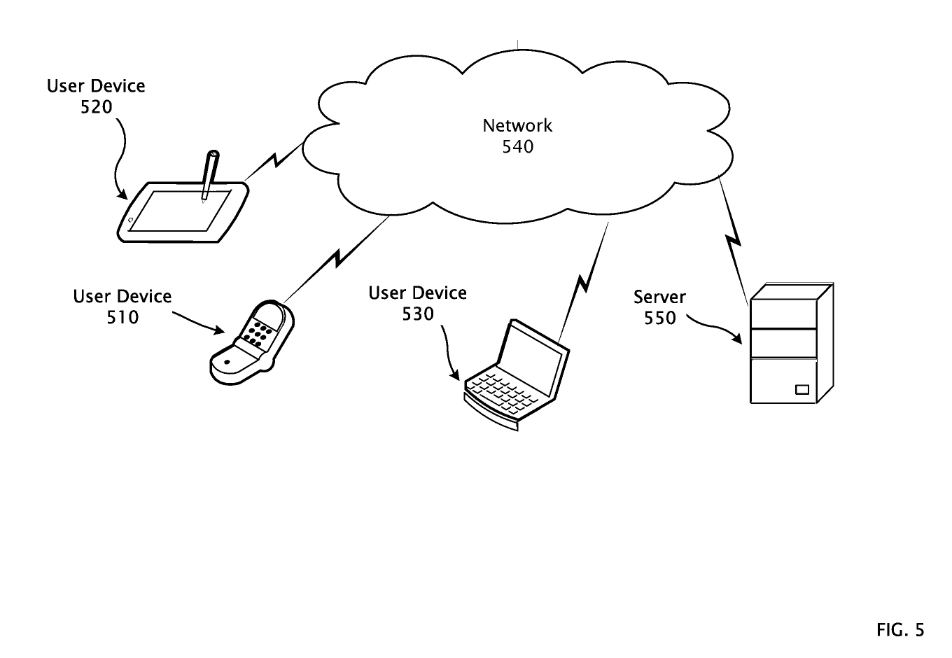

FIG. 5. is a block diagram illustrating an example of a system capable of supporting a Cause Tracking Service, according to one embodiment. Network 540 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 540 may comprise Ethernet connectivity. In another embodiment, Network 540 may comprise fiber optic connections.

User Device 510, 520, or 530 may be a smartphone, tablet, laptop computer, smartwatch or intelligent eyewear, or other device, and may have location-based services, for example, GPS, cell phone tower triangulation capability, or accelerometers, and may have network capabilities to communicate with Server 550. Server 550 may include one or more computers, and may serve a number of roles. Server 550 may be conventionally constructed, or may be of a special purpose design for processing data obtained from a Cause Tracking Service. One skilled in the art will recognize that Server 550 may be of many different designs and may have different capabilities.

User Device 510, 520, or 530 may include device application to support Cause Tracking Service, for example, allowing a user to request an action such as enter values for the name of causes they care about, or the name of businesses they need to make a decision about. In another embodiment, Device 510, 520, or 530 may display a website hosted on Server 550 in a browser, which may allow a user to request an action.

In one embodiment, Server 550 may be operated by a party other than a user or an establishment offering Cause Tracking Service. Server 550 may be operated by an establishment, allowing a worker to receive a notification of the requested action.

In another embodiment, Server 550 may be operated directly by an establishment offering Cause Tracking Service. In this embodiment, a user using User Device 510, 520, or 530 may request an action. User Device 510, 520, or 530 may communicate with Server 550 via Network 540, and Server 550 may notify a worker of the request.

An establishment may also provide a User Device 510, 520, or 530 to a user to provide access to a cause tracking service.

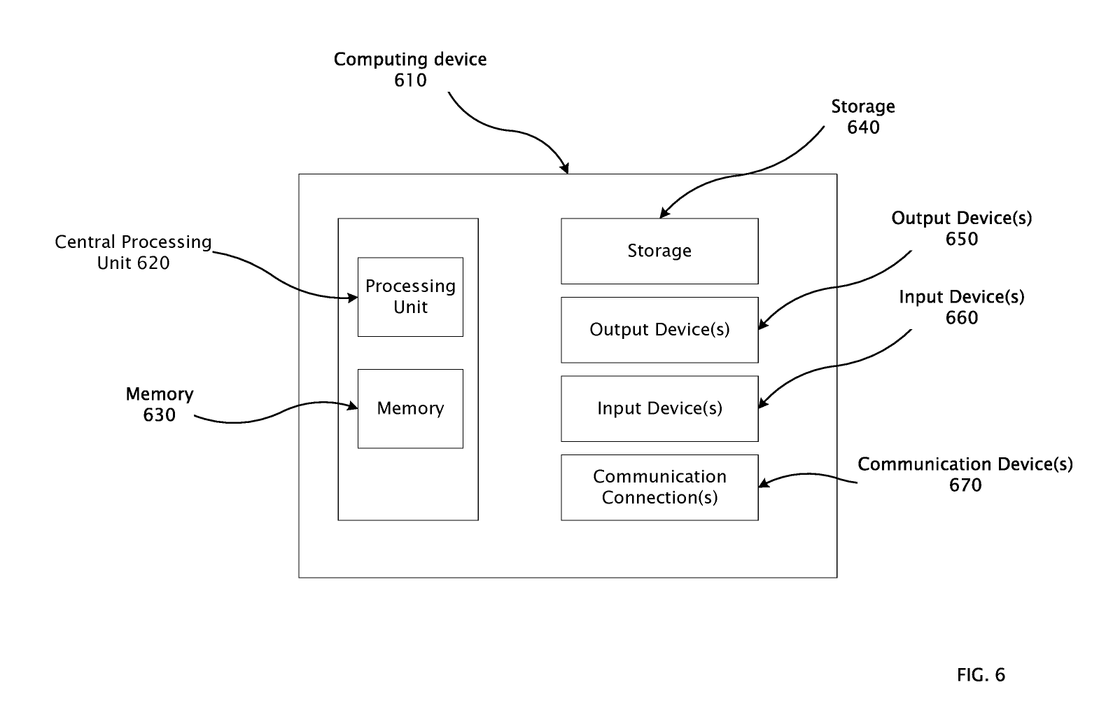

FIG. 6 is a component diagram of a computing device which may support a cause tracking service process according to one embodiment. Computing Device 610 can be utilized to implement one or more computing devices, computer processes, or software modules described herein, including, for example, but not limited to a mobile device. In one example, Computing Device 610 can be used to process calculations, execute instructions, and receive and transmit digital signals. In another example, Computing Device 610 can be utilized to process calculations, execute instructions, receive and transmit digital signals, receive and transmit search queries and hypertext, and compile computer code suitable for a mobile device. Computing Device 610 can be any general or special purpose computer now known or to become known capable of performing the steps or performing the functions described herein, either in software, hardware, firmware, or a combination thereof.

In its most basic configuration, Computing Device 610 typically includes at least one Central Processing Unit (CPU) 620 and Memory 630. Depending on the exact configuration and type of Computing Device 610, Memory 630 may be volatile (such as RAM), non-volatile (such as ROM, flash memory, etc.) or some combination of the two. Additionally, Computing Device 610 may also have additional features/functionality. For example, Computing Device 610 may include multiple CPU's. The described methods may be executed in any manner by any processing unit in computing device 610. For example, the described process may be executed by both multiple CPUs in parallel.

Computing Device 610 may also include additional storage (removable or non-removable) including, but not limited to, magnetic or optical disks or tape. Such additional storage is illustrated by Storage 640. Computer readable storage media includes volatile and nonvolatile, removable and non-removable media implemented in any method or technology for storage of information such as computer-readable instructions, data structures, program modules or other data. Memory 630 and Storage 640 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 610. Any such computer-readable storage media may be part of computing device 610. But computer-readable storage media does not include transient signals.

Computing Device 610 may also contain Communications Device(s) 670 that allow the device to communicate with other devices. Communications Device(s) 670 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 610 may also have Input Device(s) 660 such as a keyboard, mouse, pen, voice input device, touch input device, etc. Output Device(s) 650 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A user interface, comprising:
a list of causes;
a means to select a cause from the list; and
a means to find an entity which supports the selected cause.

2. The user interface of claim 1 wherein the entity is a business or non-profit organization.

3. The user interface of claim 2, further comprising a means to restrict the means to find an entity to find an entity within a specified geographic area.

4. The user interface of claim 2, further comprising the ability to find the entity based on the type of entity.

5. A user interface, comprising:
a method to enable a volunteer to check-in to a volunteer opportunity; and
a means for taking a photo of the volunteer during the check-in.
